(19) United States
(12) Patent Application Publication
(10) Pub. No.: US 2005/0142404 A1
(43) Pub. Date: Jun. 30, 2005

(54) Gas generation arrangement and method for generating gas and a power source utilizing generated gas

(76) Inventors: Craig J. Boucher, Simsbury, CT (US); Leonard J. Mecca, Avon, CT (US); Carl Mallery, Simsbury, CT (US)

Correspondence Address: CANTOR COLBURN LLP, 55 Griffin Road South, Bloomfield, CA, 06002, US

(21) Appl. No.: 11/001,836

(22) Filed: Dec. 2, 2004

Related U.S. Application Data
(60) Provisional application No. 60/527,465, filed on Dec. 5, 2003.
(60) Provisional application No. 60/552,310, filed on Mar. 10, 2004.

(51) Int. Cl. H01M 8/06; H01M 8/04; F28D 1/00

(52) U.S. Cl. 429/20; 429/22; 422/198

(57) ABSTRACT

Disclosed herein is a gas generation arrangement. The arrangement includes an initiating element in operable communication with a heat generating material. The heat generating material is positioned so that thermal energy causes the gas evolution material to decompose to evolve a target gas. Further disclosed herein is a portable power source having a gas evolution arrangement and a fuel cell in operable communication therewith. A control having at least one sensor is in operable communication with both the gas evolution arrangement and the fuel cell.

### CROSS-REFERENCE TO RELATED APPLICATIONS

This application claims the benefit of an earlier filing date from U.S. Serial Number Ser. No. 60/527,465 filed Dec. 5, 2003 and Ser. No. 60/552,310 filed Mar. 10, 2004, the entire contents of which are incorporated herein by reference.

### BACKGROUND

Gases in general are used for many different purposes in many different industries including the generation of electrical power. Often gases are produced in one location and transported to another location in a pressure vessel to be used at the second location. Such pressure vessels are large, unwieldy, and heavy. This can be a drawback in many cases. One particular example wherein the use of such containers is a drawback may be in applications requiring easily portable generation of electrical power to power electrically driven devices. In many cases in modern society, individuals will carry multiple devices requiring portable power sources. In such situations, it is infeasible for the individual to carry around a large heavy pressure vessel containing a gas to be used for electrical power generation. The most ubiquitous power sources for such devices tend to be batteries. Commonly, these are lead acid, nickel cadmium, nickel metal hydride, and lithium ion batteries. Batteries are a mainstay and widely accepted in modern society. A drawback of batteries however is that for some applications, the stored energy times are insufficient for the intended use. For such applications, power sources boasting larger stored energy times are needed. Moreover, since many users continually seek longer discharge times, for even the common battery powered devices, the noted need is growing.

### SUMMARY

Disclosed herein is a gas generation arrangement. The arrangement includes an initiating element in operable communication with a heat generating material. The heat generating material is positioned so that thermal energy causes the gas evolution material to decompose to evolve a target gas.

Further disclosed herein is a portable power source having a gas evolution arrangement and a fuel cell in operable communication therewith. A control having at least one sensor is in operable communication with both the gas evolution arrangement and the fuel cell.

### BRIEF DESCRIPTION OF THE DRAWINGS

Referring now to the drawings wherein like elements are numbered alike in the several Figures:

FIG. 1 is an exploded perspective view of an embodiment of a gas generation arrangement;

FIG. 2 is a perspective view of a portion of a barrier employable within a gas generation arrangement as disclosed herein, and having a cylindrical dimple configuration;

FIG. 3 is a cross-sectional view of one of the cylindrical dimple configurations of FIG. 2, also including an initiating element, a pyrotechnic, and a gas evolution material;

FIG. 4 is a cross-sectional view of an alternate dimple configuration, wherein the dimple is semi-circular at the end of the cylindrical body;

FIG. 5 is a cross sectional schematic representation of another embodiment of a dimple utilizing a part-spherical configuration;

FIG. 6 is a schematic depiction of the component relationship for a power generation embodiment;

FIG. 7 is an alternate embodiment of a gas evolution arrangement, which expands gas evolution potential;

FIG. 8 is another schematic depiction of a component relationship where evolution capability is expanded;

FIG. 9 is a perspective view of an alternate shape for the gas evolution arrangement;

FIG. 10 is a schematic view of a “clip” for gas evolution material;

FIG. 11 is a schematic illustration of a ball barrier as disclosed herein;

FIG. 12 is a flow chart of a control layout for this disclosure;

FIG. 13 is a schematic view of an alternate embodiment of a gas generation arrangement utilizing lithium borohydride;

FIG. 14 is a plan view of a fuel element embodiment;

FIG. 15 is a perspective view of the element of FIG. 14;

FIG. 16 is a plan view of another fuel element embodiment;

FIG. 17 is a perspective view of the element of FIG. 16;

FIG. 18 is a plan view of another fuel element embodiment;

FIG. 19 is a perspective view of the element of FIG. 18;

FIG. 20 is a plan view of another fuel element embodiment;

FIG. 21 is a perspective view of the element of FIG. 20;

FIG. 22 is a plan view of another fuel element embodiment;

FIG. 23 is a perspective view of the element of FIG. 22;

FIG. 24 is a plan view of another fuel element embodiment;

FIG. 25 is a perspective view of a layup to form a volute of FIG. 24;

FIG. 26 is an enlarged view of a flow channel in the volute of FIG. 24;

FIG. 27 is an exploded view of another embodiment hereof;

FIG. 28 is an exploded view of a fuel element assembly;

FIG. 29 is an exploded view of an initiator assembly;

FIG. 30 is a schematic view of fuel elements and initiators on opposite sides of a board; and

FIG. 31 is an electronics schematic for a control function of an embodiment of the devices disclosed herein.

### DETAILED DESCRIPTION

In the following detailed description, applicants will first describe embodiments related to the generation of a target gas divorced from the use of that gas, followed by a system utilizing an embodiment of the gas generation arrangement to provide a fuel source for a power generation device such as a fuel cell, the system including a controller employed to optimize functioning of the system. It should be appreciated that some of the examples herein are related to pyrolytic decomposition of a gas evolution material and some are related to a hydrolytic decomposition of a gas evolution material. In these systems the gas releasing agent is heat and water respectively. Gas releasing agent as used herein is intended to indicate heat, water, or other agent capable of releasing a target gas.

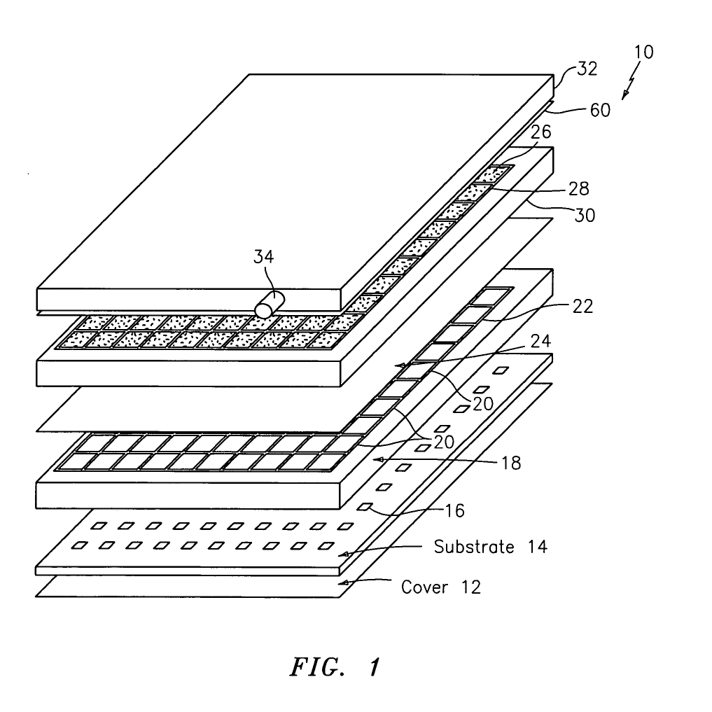

Referring to FIG. 1, one embodiment of a gas generation arrangement is illustrated. The arrangement 10 generally includes a cover 12 and a substrate 14 to mount an initiating element 16, adjacent the cover 12. A heat operating material holder 18 having a plurality of individual recesses 20, the recesses being dimensioned, positioned, and configured to receive a heat generating material 22. In assembled form the heat generating material is positioned adjacent the initiating element l6. A barrier 24 is positioned adjacent the heat generating material for various purposes in different embodiments such as to modify heat output from the heat generating material, to segregate the heat generating material from a gas evolution material 26, etc. The gas evolution material is contained in a gridwork 28 defining individual cells 29 of material 26. Each cell, in the assembled condition of the arrangement, is in register with a recess 20 in the material holder 18. The gridwork 28 is supported in a gas evolution material holder 30. Adjacent to gas evolution material 26 is a gas manifold and cover 32, which further includes an output port 34.

When the enumerated components are assembled, the heat generating material and the gas evolution material are in register and will communicate with one another as intended and described herein. It is important to note that in one embodiment, barrier 24 must be in place between the heat generating material 22 and the gas evolution material 26, as direct contact between these materials is contraindicated in such embodiment. In other embodiments the barrier functions only to modify heat output of the heat generating material 22, and in yet other embodiments the barrier may be used for both of these purposes simultaneously.

Cover 12 may be of any material calculated to have properties conducive to the intended end use of the arrangement. Such materials may potentially be metals or plastics, among others and are not particularly critical to the function of the arrangement. Heat, chemical species and impact resistance are the primary properties to be considered in selecting a material. It is important to point out that the weight of the selected material should be as low as possible, providing the material also possesses the above noted properties.

The substrate 14 has for its purpose to mount the initiating elements 16, which may be semiconductor bridge initiating elements commercially available from SCB Technologies, Inc. of Albuquerque, N. Mex., and supply a pathway for a control signal to reach the initiating elements. The substrate material may be a dielectric material and will have a low thermal conductivity to reduce heat loss in some embodiments. Reduced heat loss improves gravimetric and volumetric efficiency of the arrangement.

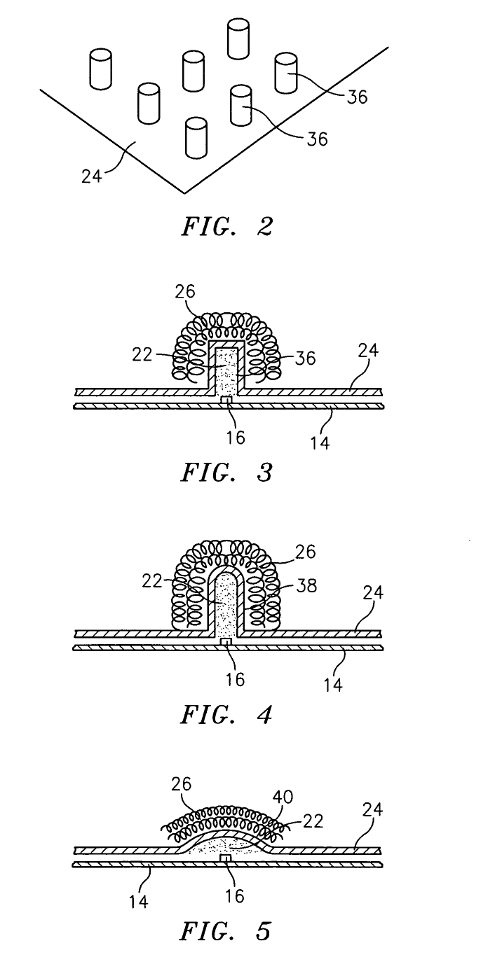

The heat generating material holder 18 may be, as illustrated in FIG. 1, a separate component from that of the barrier 24 or may be integrated with the barrier as is the case in the alternate embodiments illustrated in FIGS. 2-5. In the FIG. 1 embodiment, where the holder 18 is distinct from the barrier, it may be constructed of materials having sufficient insulative properties to avoid the unintentional ignition of a neighboring heat generating material 22 when another volume of heat generating material is ignited. Furthermore, in the FIG. 1 embodiment, the insulative properties are required to reduce heat loss in directions of heat propagation that do not directly impact the gas evolution material 26. Alternatively, in the FIGS. 2-5 embodiments, the holder is integrated with the barrier. In this embodiment the material need merely have the requisite properties of a barrier (discussed hereunder) and have a thermal conductivity insufficient to ignite a neighboring heat generating material 22. In the FIG. 1 embodiment, the holder 18 should have properties sufficient to withstand heat, chemical species and impact as portions of the holder 18 in this embodiment will be exposed to the environment. It is further noted that the heat generating material holder 18, or the barrier 24 in the FIGS. 2-5 iterations will also maintain the heat generating material in contact with the initiating elements 16 when in the assembled condition.

As noted above, in some embodiments, the heat generating material 22 is to be maintained apart from the gas evolution material 26 due to potential deleterious chemical interaction having a negative affect on the efficiency of the arrangement and the purity of the evolved target gas. In such embodiments selected barrier 24 should prevent oxidation and/or contamination of the target evolved gas or of the gas evolution material itself. This alleviates potential problems in the system related to other reactions at the gas evolution material that might hinder or prevent target gas evolution. Moreover chemical interactions with the target gas can potentially affect its usefulness and can damage the fuel cell portion of the system. In the FIG. 1 embodiment, this is the job of barrier 24. Barrier 24 will optimally be a material having a low chemical interactivity with the selected heat generating material, yet have sufficient integrity to withstand the specific energy generated by the material 22. The barrier may also in some embodiments be carefully selected/configured to manage thermal conductivity. This allows greater control of the rate at which hydrogen gas (or other target gas) is generated. Such control can be beneficial, since in some embodiments, a fast gas evolution rate may push gas evolution material away from the heat source reducing the ability of the system to provide sufficient thermal energy to the gas evolution material to evolve the target gas. In any event, in embodiments where the foregoing chemical interaction is an issue, the barrier will minimally avoid contact between the heat generating material and the gas evolution material. Acceptable materials for barrier 24 include aluminum, copper, steel, ceramic (in some embodiments metal filled ceramics may be used to increase thermal conductivity), cermet, tungsten, titanium and other materials having similar properties, those materials including compound materials such as alloys containing at least one of the foregoing materials. It will be appreciated that these materials have vastly differing thermal properties. This is to be considered when constructing a system as disclosed herein relative to the rate of heating of the gas evolution material. It will also be appreciated that the heat generated will eventually be conducted into the immediate environment of the heat generating material at least a portion of which will be the gas evolution material. Thus, the design point consideration will be one of how quickly the thermal energy should conduct in a given application.

In one embodiment, the heat generating material is a pyrotechnic material and may be a thermite material. Such materials commonly generate heat on the order of 2500 degrees Centigrade, have a very high caloric output to weight ratio, and they produce little or no gas when burned. Pyrotechnics contemplated include various combinations of fuels and oxidizers. Examples of these (by no means an exhaustive list) are as follows: Aluminum/Cupric Oxide; Aluminum/Ferric Oxide; Silicon/Cupric Oxide; and Silicon-Boron/Ferric Oxide among others. Further it is noted that several other combinations can be made employing the following exemplary fuels and oxidizers:

Fuels:
Aluminum (Al)
Boron (B)
Silicon (Si)
Titanium (Ti)
Zirconium (Zr)
Molybdenum (Mo)

Oxidizers:
Cupric Oxide (CuO)
Ferric Oxide (Fe2O3)
Tin Dioxide (SnO2)

Titanium Dioxide (TiO2)

Stoichiometric Heat of Reaction (cal/g)

| | Fuel | | | | | |
|---|---|---|---|---|---|---|
| Oxidizer | Al | B | Mo | Si | Ti | Zr |
| CuO | −983 | −1160 | −160 | −1220 | −698 | −735 |
| Fe2O₃ | −950 | −581 | No | −551 | −563 | −641 |
| | | | reaction | | | |
| SnO₂ | −682 | −378 | No | −371 | −399 | −493 |
| | | | reaction | | | |

It has been found that three component systems utilizing two fuels and one oxidizer improve ignition and burn characteristics. In one embodiment the heat source material will comprise Silicon at 16% (wt), Boron at 4% (wt) and Ferric Oxide at 80% (wt). The average particle size for this embodiment is about 1 micrometer.

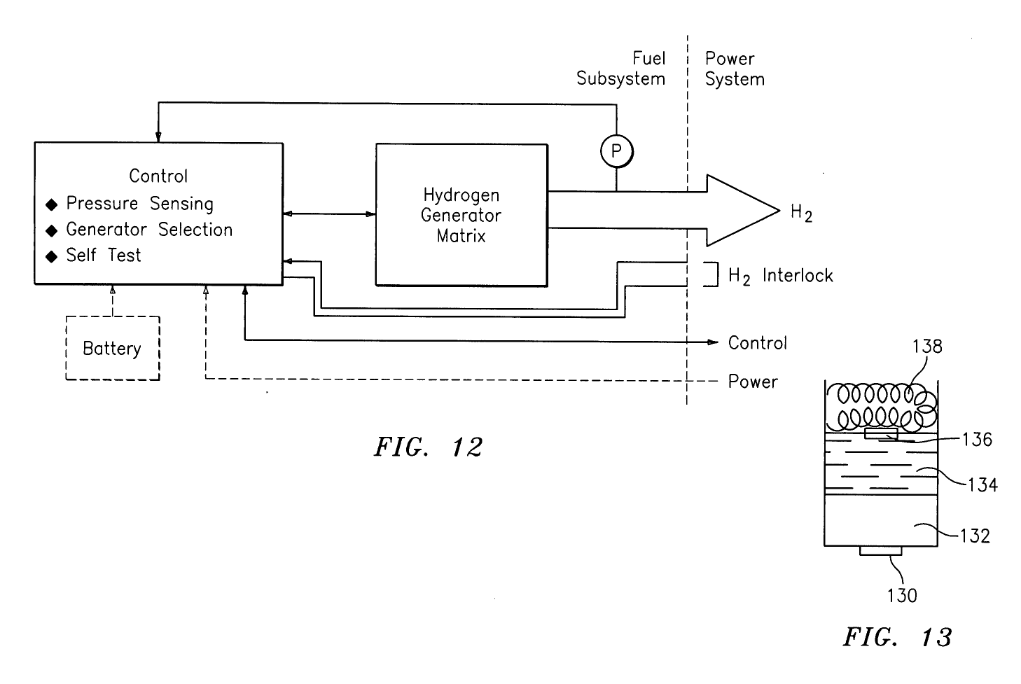

In one embodiment, gas evolution material, as stated above, is disposed in a gridwork 28 that maintains the material 26 in distinct cells 29. Each cell 29 is intended to evolve gas pyrolytically by itself without the induction of other cells, although other cells may be intentionally pyrolyzed, if desired. The intent is that the cells not cause pyrolysis in each other. This is relevant primarily for gas evolution materials in which there is a risk of a runaway pyrolytic decomposition. The desire to prevent such a self-sustained reaction is based substantially upon two grounds: first, unintentional pyrolysis of the material 26 generates unneeded and therefore unwanted gas, which gas will likely be lost through venting and second, such activity decomposes the gas evolving material to the detriment of the intended discharge time of the arrangement. The gridwork 28 is therefore selected from a material or materials that have sufficient insulative properties and will be sufficiently non-reactive with the gas evolving material to achieve the stated goal. It is noted however, that upon observation, ammonia borane does not suffer significantly from a tendency to propagate the pyrolitic decomposition. Rather this material will evolve hydrogen only when it reaches a certain temperature. In areas of the material that do not reach requisite temperature(s) the material stays in whatever form it has already achieved. This includes material that evolves the first wave of hydrogen at about 120 degrees but does not reach the next temperature milestone to evolve the second wave, etc. Where ammonia borane is the gas evolution material, an alternate embodiment of the device is possible which does not include a gridwork to separate cells of gas evolution material, but rather the material may be in a larger contiguous section. The gas evolution material is stable after heating to the first or second levels and will remain ready to evolve the third or second and third levels when prompted to do so by a temperature input of sufficient magnitude. Therefore gas generation from the device can be stopped at any time by removing the thermal input. This property is responsible for one of the important benefits of the arrangement in that even a partially used gas evolution material volume is stable over time and releasable on demand. The ability to package the gas evolution material and have it remain stable over time also allows the packaging of the material as a “clip” such as illustrated in FIG. 10, which can be replaced in the gas generation device. Gas generation, and therefore electric energy can then be had for extended periods by simply swapping out “clips” of the gas generation material. FIG. 10 is addressed further later in this application.

Finally, the gas manifold and cover 32 is positioned adjacent the gridwork 28 to collect and convey the evolved gas to the output port 34. The material of the manifold and cover 32 will be of a material having properties similar to the cover 12 providing that the cover 32 may have additional resistance to the evolved gas, if necessary.

It is important to recognize that the particular components discussed in this application represent but a few configurations that are possible within the overall disclosure hereof. Moreover, “configurations” as used in this sentence also relates to physical shape of the device and it should be noted that several gas generative “volumes” could be piped together to increase capacity and spread heat load/heat signature if desired. At a more essential level, the disclosed concept is directed to the evolution of a target gas by using a heat source, segregated from a target gas evolution material, to pyrolytically evolve the target gas. The heat source need be controllably actuable and the arrangement need have a means to collect and convey the target gas. Other aspects are variable and further embodiments are disclosed herein.

Prior to discussing operation of the arrangement, reference is made to FIGS. 2-5 where alternate configurations employing dimples of varying depths are illustrated in schematic cross section. In such illustrations, the barrier 24 is deformed such that cylinders 36 in FIG. 2 and FIG. 3; round end cylinders 38 in FIG. 4; and part-spherical deformations 40 in FIG. 5 are formed. The purpose of the deformations is to receive on one side the heat generating material 22 and provide on the opposite side a large contact area with the barrier surrounding the heat generating material for the gas evolution material 26 as illustrated. Each of the embodiments of these Figures takes advantage of greater heat transfer efficiency. As one of ordinary skill in the art is aware, heat emanates from a heat source in all directions. In simplified terms one could say heat emanates in six directions (up, down, left, right, forward and back or y-positive/negative, x-positive/negative, and z-positive/negative). Viewing FIGS. 2-5 one will appreciate that to varying degrees these embodiments take advantage of each stated direction of heat flow except down or y-negative. This is because the gas evolution material is positioned in these embodiments at all of those directions relative to the heat generating material except down or y-negative. Less heat energy is lost in such a configuration. This may be advantageous relative to the FIG. 1 embodiment since greater effect may be taken from the heat generating material but in addition, lesser insulative qualities are needed for the effective pyrotechnic holder 18 around the heat generating material; indeed insulative qualities are not necessarily needed. Compactness of the resulting arrangement is also enhanced. Since in one embodiment this arrangement is intended to act as a human carryable power generation device, reduction of component weight is desirable.

In yet another embodiment illustrated as FIG. 11, all directions are taken into account relative to heat conduction. This is accomplished by placing the heat generating material in a discrete barrier ball 120. The ball 120 would be fed with, for example, a wire 122 to ignite the initiating element. Heat then would propagate in all directions into gas evolution material 124.

Target gas evolution is effected by sending a control signal to an initiating element 16, which will then attain a temperature sufficient to cause the heat generating material directly in contact therewith to create heat. In one embodiment, as noted above, the initiating element is a semiconductor bridge such as that disclosed in U.S. Pat. Nos. 4,708,060, 4,976,200, 5,179,248, and 5,309,841, all of which are incorporated herein by reference, and the heat generating material is a pyrotechnic, which may be a compound of one or more of the listed fuels and oxides, a compound including one of the listed fuels or oxides or other suitable heat generating materials. It is noted that in some embodiments of this invention, heat generating materials (as opposed to the gas evolution materials) having no or very little gas production on ignition will be preferred. This simplifies the resulting arrangement, as expanding gases from the heat generating material need not be dealt with. In other embodiments, heat generating materials also produce hydrogen or other target gas, or a gas that enhances or facilitates target gas production such as, for example, lithium borohydride, sodium borohydride, etc.

In alternate embodiments, the initiating elements are a thick film deposition, thin film deposition, bridge wires, foil bridges, etc., each of which on their own are art recognized initiating elements. For any initiating element some energy input is required. Where electrical energy is employed, the energy may come from a battery (such as a watch battery) from the fuel cell of this arrangement (although this may in some applications be considered overly detractive of gravimetric efficiency), or a piezo device (in the event a mechanical initiation is needed). In other embodiments, initiation can be effected by impact firing arrangement (such as a primer) or by using a low pressure source such as a frangible ampule in operable communication with a metal hydroxide evolution material. This could be a one cell portion used only at start-up. Continued operation would in this embodiment use energy from the fuel cell to ignite other initiators. It is also noted that cell size can be varied to tailor gas production to usage. For example, the first cell fired might be larger to initially fill the system with hydrogen gas. Another example will have multiple sizes of cells that are addressable by the controller (discussed hereunder) and will be fired based upon usage need.

The semiconductor bridge is a desirable initiating element since it provides a high temperature while utilizing only a very small amount of energy. Energy on the order of 300 microjoules is sufficient to fire an initiating element 16 where that initiating element is a semiconductor bridge, which makes the entire arrangement much more efficient than it might be utilizing another type of initiating element (such as a simple resistance element) that would require significantly more energy to operate. Once the initiating element is fired, the heat generating material will create heat. The heat will be transmitted conductively through barrier 24 to a gas evolution material 26 which will pyrolytically decompose to release the target gas. In one particular example, the gas evolution material may be an ammonia borane with hydrogen as the target gas to be evolved. Ammonia borane (NH₃BH₃) is approximately 20% by weight hydrogen, which makes it an attractive chemical hydride for the purpose of pyrolytically evolving hydrogen gas. Notably, ammonia borane is also hygroscopic, and the moisture content can be adjusted at time of manufacture such that moisture evolution with the target gas can be controlled. Such control is very beneficial where the evolved gas is intended to be used as a fuel source for a fuel cell. Fuel cells, and particularly PEM (proton exchange membrane) cells, require moisture to operate properly. Due to the hygroscopicity of the material, the amount of water vapor being provided to the fuel cell can be regulated for optimal performance. In alternate embodiments some cells that would otherwise contain gas evolution material are filled with water or a water-bearing compound such as clay or diatomaceous earth. The desired compounds will be selected for high moisture holding capability and relatively inert reactive properties so that upon heating, moisture will be released but other species will not be released to the gas stream needed for the fuel cell. These cells can be initiated in the same manner as the gas evolution material. The high temperature generated by the heat generating material easily vaporizes the water to add humidity to the gas stream.

Upon evolution of the target gas, the gas manifold and cover 32 collects and delivers the target gas to an output port 34. The output port may be connected to any type of device depending upon what gas has been evolved. In one embodiment, the port is connected to a fuel inlet port of a fuel cell to allow the fuel cell to operate.

Not discussed above but illustrated in FIG. 1 is a filter material 60, which is an optional, additional feature that would, if used, be positioned between the gas evolution material 26 and the gas manifold 32 as shown to prevent impurities from entering the gas manifold and thereby leaving the output port 34.

Moving to the second aspect of the invention, and referring to FIG. 6, the gas generation arrangement is utilized to provide a hydrogen fuel for a fuel cell 62 to generate electricity in a small, lightweight, and efficient power source. The purpose of such source is to satisfy the needs discussed in the “Background” section hereof regarding portable power sources. To produce hydrogen the gas generation material will be a chemical hydride and may be ammonia borane as discussed above. Because ammonia borane has 20 weight percent hydrogen content, gravimetric efficiency of the system is favorable. Ammonia borane will evolve hydrogen gas starting at about 120 degrees C. and is substantially decomposed by about 450 degrees C. The chemical decomposition of this material is also irreversible so that as any remaining unreacted hydride cools there will be no re-absorption of any evolved hydrogen. The end product of the decomposition is Boron Nitride.

The evolved hydrogen gas may then be filtered to prevent impurities from entering the fuel stream 64 to the fuel cell 62. Such impurities can relatively easily “poison” the cell stack (not shown specifically) thereby rendering the arrangement non-operational or may impair the operation thereof.

As a further component of this system, a control 66 is provided. Control 66 may operate by simply monitoring one or more sensors, may operate by sending and receiving signals, among the various components where sensors may be present or may operate as an interface with another controller or even based upon input from an operator. The purpose of control 66 is to monitor and direct the activity of the system. In a basic form this entails monitoring power usage to determine need utilizing an appropriate sensor(s), monitoring gas pressure with appropriate sensor(s), comparing the need to the available gas pressure and the known efficiency of the fuel cell 62 to provide power per unit gas. The control, then, also has the function of determining when additional gas is required and directing the “lighting” of a needed number of initiating elements that is calculated to cause the evolution of an appropriate amount of gas. In one embodiment, all of the sensing operations and all of the calculating operations will be carried out continuously to continuously adapt the system to immediate needs. As the fuel cell uses the fuel gas, the pressure of the gas will invariably drop triggering the control to light additional initiating element(s) resulting in replenished gas pressure. This will maintain efficiency and therefore longevity of the discharge of the system at optimum. Moreover, because the system is a demand system, and by design meters gas in small doses, it operates at a low pressure, enabling the use of low cost materials and enabling the device to be configured more ergonomically.

Further, with respect to control of the device it is contemplated to use pressure sensor(s) not only for the above stated purpose but also to detect leaks in the system. Since the control system is intended to track/predict usage rate of generated gas and has control of when additional gas is generated, the controller is easily programmable to recognize a leak condition, which is evident when gas usage and gas production do not coincide. Further, the same inputs (generation and usage) can be correlated to electrical energy output to determine health condition of the fuel cell stack.

The control system is also to be programmed to distribute gas generation areas around the device so that hot spots are avoided in the device so as not to exceed acceptable skin contact temperatures. This also reduces the heat signature of the device.

In addition to the foregoing, it is contemplated that the controller includes the ability to count initiators fired and where they have been fired. The controller may retain this information in non-volatile memory, which remains intact even when the system is powered off. This can then be correlated to the amount of generation capacity left. For example, if each initiator is configured to generate gas from 1% of the gas generation material, determining the remaining percentage is simply a matter of subtraction. Alternatively, the controller can be programmed to gauge usage of the device through percentage used even with each “cell” representing different percentages of the whole amount. It is also possible for the controller to predict time remaining but this is dependent upon rate of usage. The calculation can only be done in arrears however and then an anticipated amount given for future remaining time, which assumes continued use at the previous rate.

Referring to FIG. 12, one embodiment of a system to produce electrical energy is illustrated in flow chart form. The drawing is labeled with all relevant components and will be immediately understood by one of ordinary skill in the art following exposure to this specification.

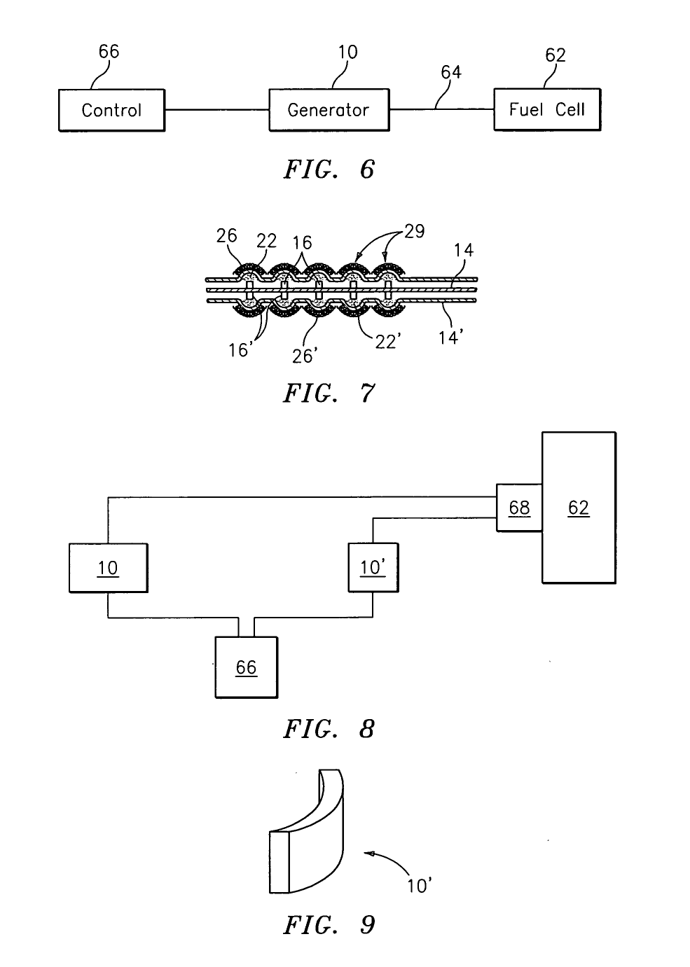

The system effectively provides much greater discharge capacity in a portable device. In addition, the system described herein can be easily expanded in several ways. Referring to FIG. 7, expansion may be effected by installing initiating elements on both major surfaces of the substrate and building a mirror image arrangement on each side of the substrate. Note that prime numerals have been employed to differentiate the sides of the arrangement. Also note that a particular embodiment of the gas generation device utilizing two sides is illustrated and described with respect to FIG. 30 hereunder. Referring to FIG. 8 it is also possible to add arrangements that are actuated by the same control and utilize different conduits to deliver gas to the fuel cell. In such embodiments a gas manifold 68 at the fuel cell may be desirable and would be an appropriate location for a gas pressure sensor. Additionally, the size of the arrangement could be expanded so that more cells 29 are available.

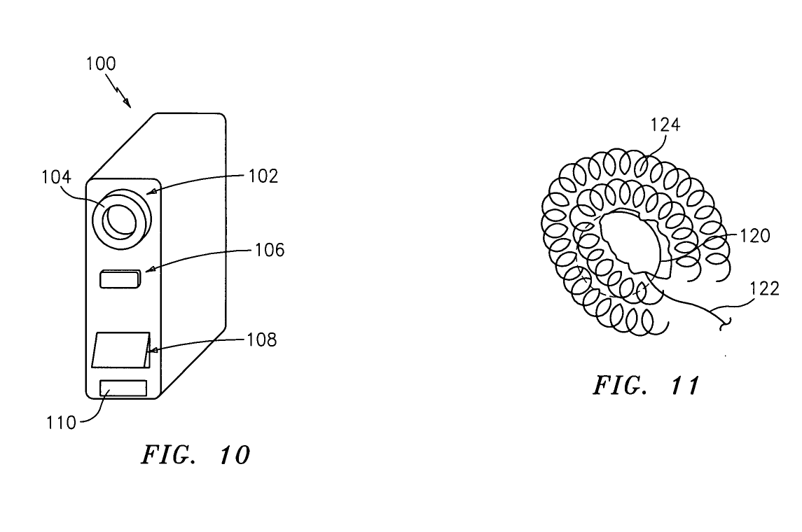

Referring to FIG. 9 it is also noted that due to the non-hyperbaric pressures under which this device is capable of operating, it is not necessary to resort to conventional pressure vessel configurations but is possible to form the arrangement 10′ in an ergonomic shape such as that illustrated. Further, it is important to note that it is the particular construction and materials employed that allows the gas evolution reaction to go at ambient pressure. Prior art reactions all require hyperbaric pressure to facilitate an effective reaction. The property of the present invention thereby facilitates the stated ergonomic shape capability as well as other capabilities. By so shaping the arrangement, it will be more comfortable for the user to carry as well as being more streamlined.

As was briefly mentioned earlier, an embodiment of the device disclosed herein includes a replaceable gas generation material clip for easy “in-the-field” replenishment of the device. Referring to FIG. 10, clip 100 includes a gas output port 102, which includes a sealing structure 104 such as an O-ring or similar contact seal structure/material and may optionally include a rupturable seal covering the port for storage. Clip 100 further includes a control connector 106 to provide for signal transmission at least to the clip (and in some embodiments from the clip) for control and monitoring of the gas evolution material in the clip and optionally for control and/or monitoring of other features of the clip. Signal transmission may be electrical, optical, etc. as desired. Clip 100 further includes a retaining feature 108 such as a selectively releasable detent or the like to physically engage clip 100 with the fuel cell system to prevent unintentional disengagement thereof.

The retaining feature 108 may also act as an interlock to prevent gas generation when the clip is not properly engaged with the fuel cell. Further, a separate interlock 110 may be provided if desired. The interlock 108/110 may be mechanical, electrical, optical, etc. and may be configured as a connector jumper, or can be a function of control signals to or from (or both) the fuel cell. In addition, if the interlock is arranged so as to be dependent upon power from the fuel cell portion of the system, it is highly fail proof. A further interlock feature will sense appropriate parameters to verify that a fuel cell is attached, that it is the correct fuel cell, that the cell is operating and that it requires the target gas at that time. In another embodiment, one need merely mechanically configure the device to cause the gas connection to engage before the electrical connection. When the electrical connection is engaged, the gas connection has to be engaged. For even more verification, the gas connection itself can be connected to a means of preventing electrical connection. Thereby, unless the gas connection is made, it is impossible to make an electrical connection. This can be accomplished for example by an interfering member that moves out of the way of the electrical connection when the gas connection is engaged.

In addition to the foregoing, it is further contemplated by the inventors hereof to utilize catalysts with the gas evolution material for several reasons. Ammonia borane, as discussed earlier contains about 20% by weight hydrogen. It is however sometimes difficult to extract all of the hydrogen. Therefore, the addition of a dehydrogenation catalyst to enhance the decomposition of ammonia borane and maximize hydrogen evolution is desirable. The addition of catalyst(s) to the ammonia borane is also beneficial in that such catalyst(s) are useful to extract (remove or reduce) impurities from the evolved gas stream or prevent their entry to the gas stream in the first place. In one example, addition of water to the system is effective in removal of ammonia from the system. In another embodiment, the catalyst(s) is/are active in binding unwanted species in a way that makes those species easily filterable from the gas stream.

In another embodiment, lithium borohydride or sodium borohydride, etc. is utilized as the gas evolution material. Lithium borohydride evolves hydrogen gas when reacted with water. Lithium borohydride may be reacted with water in a system similar to that disclosed above by thermally energizing water such that a reaction with lithium borohydride takes place. For example, FIG. 13 is a schematic representation of one possible configuration. FIG. 13 comprises an initiating element 130; a heat generating material 132; water 134; a rupture disk 136; and lithium borohydride 138. Each component is to be considered in a suitable container to retain it in position. Upon initiation of element 130, the heat generating material 132 will begin to generate heat. The heat will energize the water, turning it to steam. The pressure of the steam is calculated to be greater than the pressure containing capacity of the rupture disk 136, so that disk 136 ruptures, thereby allowing the steam to escape into the lithium borohydride and react with the same to evolve hydrogen gas. While it is recognized that the addition of water is a reduction in gravimetric efficiency, heating of the water to steam requires far less thermal energy than that of the foregoing embodiments. Therefore, the heat generating material can be substantially less, thereby again improving gravimetric efficiency. Further, additional hydrogen is obtained from the water.

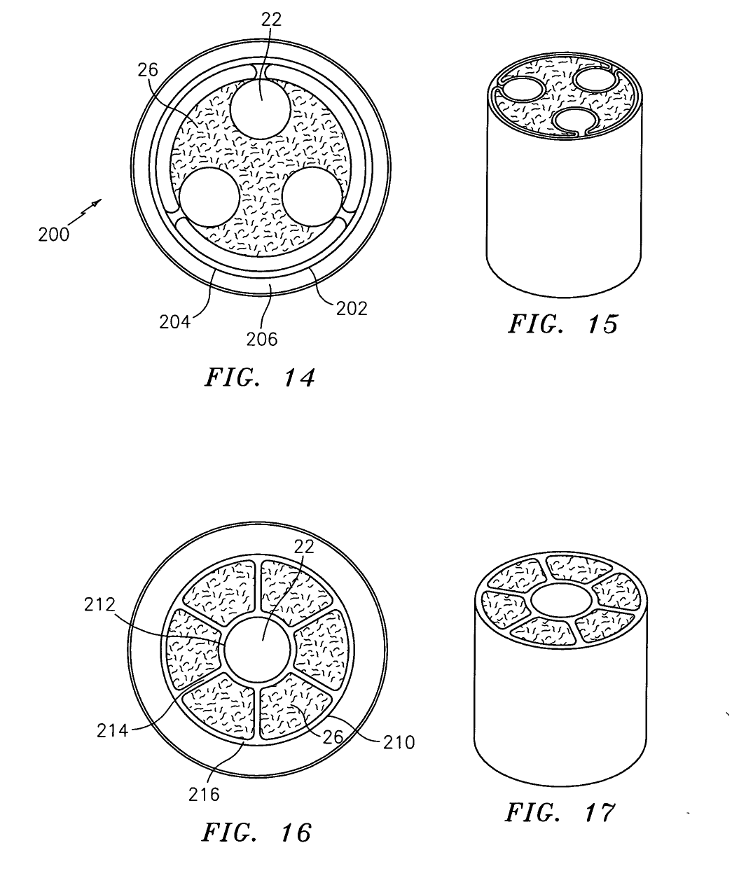

Further to the foregoing embodiments, additional embodiments are described hereunder where “Fuel elements” or “elements” comprise both the gas evolution material and the heat generating material in a single “element”, the embodiments including different configurations employing the concept. One embodiment of a fuel element 200, referring to FIGS. 14 and 15, is illustrated in plan view and in perspective view, respectively. The heat generating material 22 is disposed in columnar form disposed at about 120 degrees apart and on the outside of a housing 202 that is of a convoluted shape as illustrated. On the inside of the housing, the gas evolution material 26 is disposed. Radially outwardly of the housing 202 is sleeve 204 whose function it is to maintain the housing in shape. Space 206 is disposed radially outwardly of sleeve 204 and radially inwardly of heat shield 208 to assist in heat propagation attenuation. This element 200 is insertable in a gas generation device along with many other similar elements to make up a gas generation assembly similar to that discussed above. The gas evolution material is in one embodiment in an amount of 5.5 grams per element 200.

In another fuel element embodiment, referring to FIGS. 16 and 17 the element 200 is arranged in the form of a wheel. The heat generating material 22 is centrally located and in columnar form. Material 22 is located within a portion of the housing 210 which figuratively speaking includes a hub 212 (within which is the material 22), spokes 214, and wheel 216. Within spaces defined by two spokes 214 and a segment of the hub 212 and wheel 216 is the gas evolution material 26. Outwardly adjacent the housing 210, the embodiment is similar to the foregoing embodiment.

In yet another configuration of the element 200, referring to FIGS. 18 and 19, the element is in the form of a parallelogram. The heat generating material is located centrally and within the hub 212 of the housing 218. Spokes 214 are positioned to arrange the gas evolution material in quadrants and are heat conductive to help move heat energy to more remote portions of the gas evolution material. Again, the housing is provided with an outwardly adjacent structure similar to the structures of the embodiments of FIGS. 14-17.

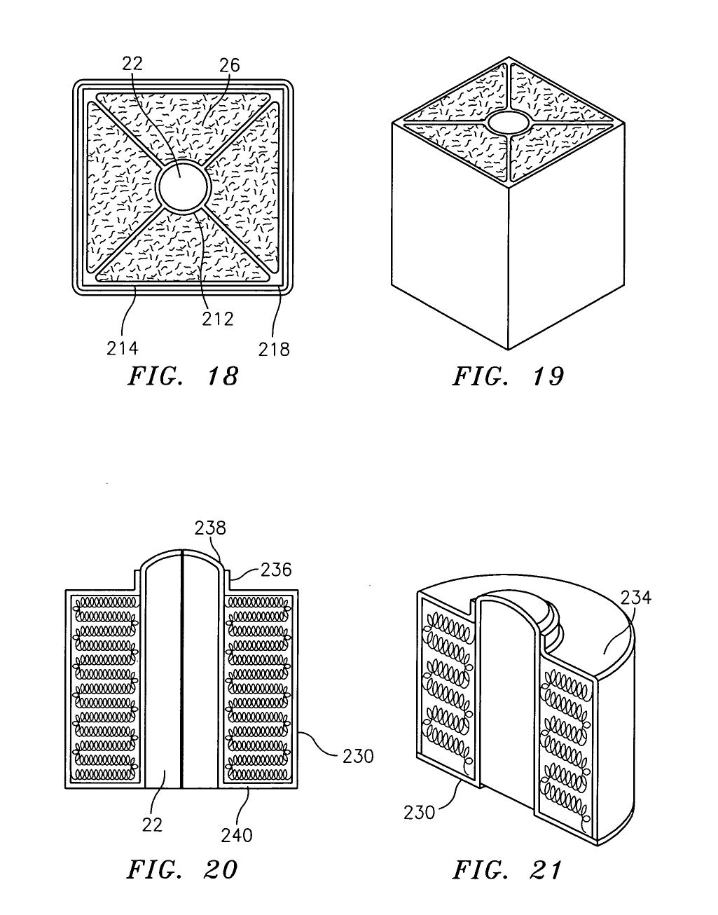

Referring now to FIGS. 20 and 21, another arrangement for the fuel element is illustrated. In this embodiment the housing 230 comprises a cylindrical (could be other tubular shape) shape with one open end 232 and one substantially closed end 234. Gas evolution material 26 is inserted in the housing in a tubular shape to fill a void between the housing and container (described hereunder). The end 234 includes a press-fit lip 236. The heat generating material 22 is enclosed within a container 238, which container has a cross-sectional shape that agrees with the shape of the lip 236 so that the lip 236 and the container 238 are capable of forming a press fit together when assembled. It is further noted that container 238 advantageously includes a flange 240 which is configured and dimensioned to close the open end 232 of the housing when the container is inserted into the housing. This is very easy to manufacture arrangement since all punched parts are used.

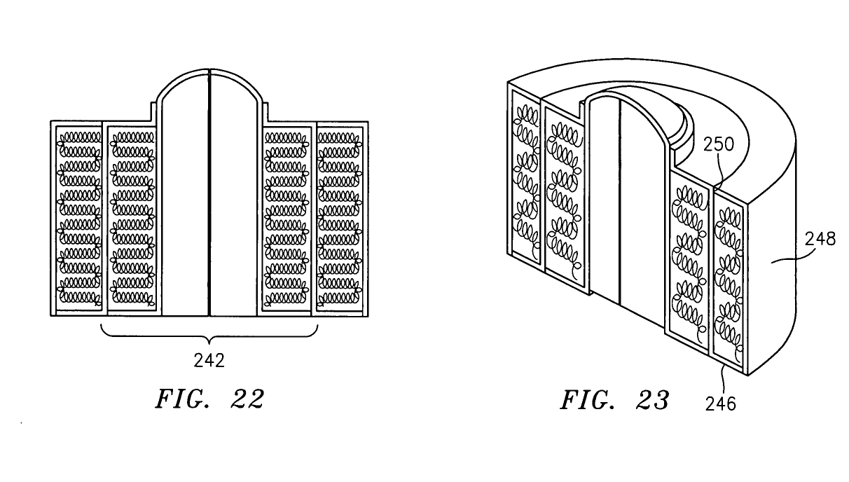

In an embodiment similar to FIGS. 20 and 21, reference is made to FIGS. 22 and 23. In this embodiment the gas evolution material is also tubularly configured but is so in two nested tubes. The structure of the inner portion of the embodiment, bracketed as 242, is identical to the foregoing embodiment illustrated in FIGS. 20 and 21. Dimensions are not necessarily the same but construction is almost identical. The first distinction is in a flange 246 on housing open end 232. It will be apparent that this is one end of a further tubular containment structure for additional gas evolution material. The additional gas evolution material is further surrounded by second housing 248, which abuts housing 230 at flange 246 and at edge 250. This embodiment will generally be selected where it is desired to split the gas evolution material to bring more heat thereto for pyrolytic decomposition. This is effected by the utilization of the housing 230 as a heat conductor for gas evolution material decomposition rather then simply as a holder as is the case in the FIG. 21 embodiment.

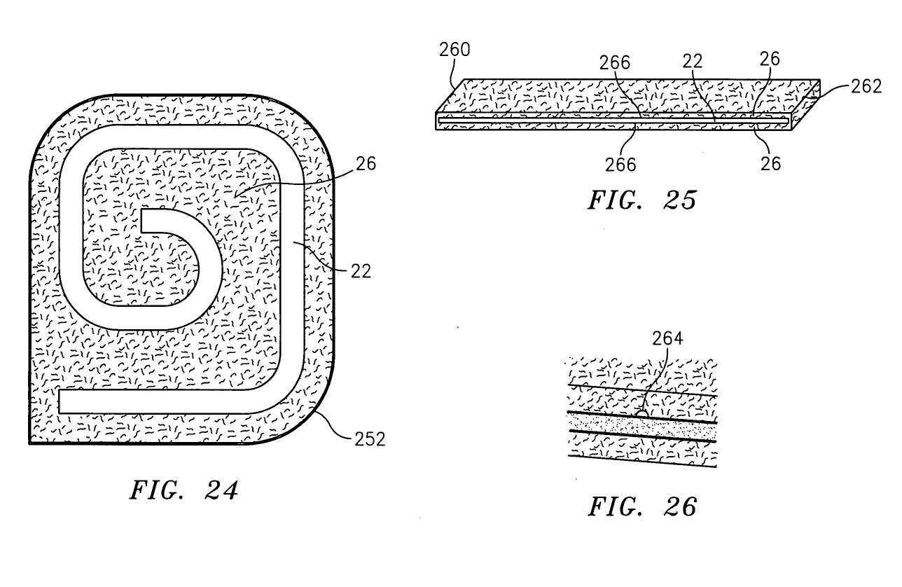

In a further fuel element embodiment, referring to FIG. 24, the gas evolution material and the heat generating material are constructed as a volute. A foil jacket 252 is utilized around the outer surface of the element. To manufacture this embodiment, a five-layer lay-up of materials is prepared. This is illustrated in Figure 25. This lay-up comprises a layer of gas evolution material 26, a layer of foil (ex. aluminum) 266, a layer of heat generating material 22, another layer of foil 266 and another layer of gas evolution material 26. This is then rolled from one end 260 to the other end 262 to form a volute. The volute is then compacted into a rounded parallelogram shape in one embodiment, to maximize space utilization. Once the element is compacted the foil jacket 252 is applied to the outside surface of the volute element. In one variation of the volute embodiment (see FIG. 26) gas flow channels 264 are provided at intervals along the interface of the gas evolution material and the foil. While the channels may be provided anywhere, it is easier to simply compact the channels into the gas evolution material as the lay-up is being created. These channels help to release the evolved gas both delivering the gas to the target area more rapidly and to avoid buildup of potentially insulating gas between the gas releasing agent and the gas evolution material. More or fewer of these channels may be employed as desired.

Some of the benefits of using the volute embodiment of the fuel element include that it is very easily scalable in that the number of turns and length of the materials can be adjusted as needed; the gas evolution material is maintained in a thin layer for excellent heat transfer; housing mass for the element is quite nearly eliminated; and heat loss is minimized.

Utilizing the volute embodiment of the fuel element as an example, an alternate gas generation assembly is illustrated. Although many of the constituent parts of this embodiment of the gas generation assembly are similar to those discussed in FIG. 1 they are not all necessarily identical. Therefore to avoid potential confusion in disclosure, new numerals are employed in the discussion of this alternate embodiment.

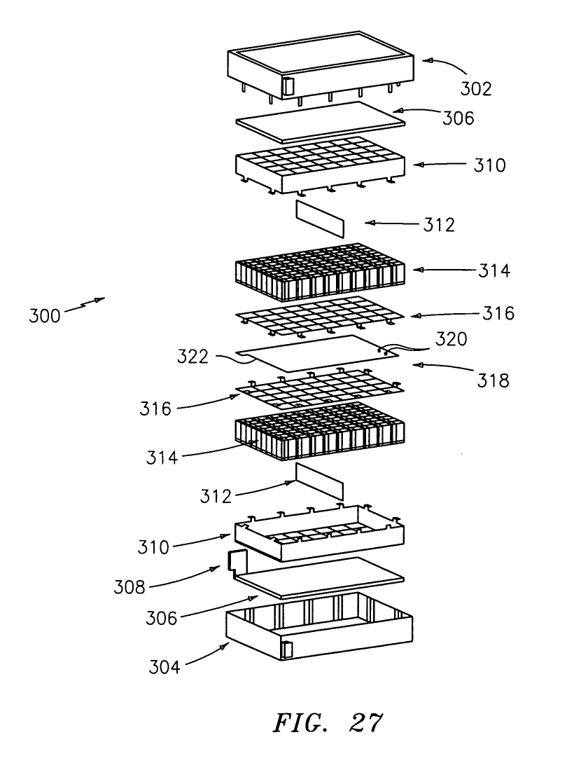

Referring to FIG. 27, eighty 10 W-hr elements are positionable within a device weighing approximately one kilogram. The device is illustrated in exploded form for convenience. The device 300 is packaged within a top cover 302 and a bottom cover 304, which may comprise a thermoplastic polymer elastomer such as Dupont HYTREL™ material. The material of choice should have a relatively high melt temperature, for example about 220 degrees Celsius and should have relatively low thermal conductivity. All of the components of the device 300 are stacked within the confines of the covers 302 and 304. Each of the components will first be identified and then discussed to the extent necessary to provide a clear understanding of what is disclosed. At the bottom (in the drawing; orientation of the device is irrelevant) a particulate filter 306 is illustrated with a gas filter 308 (sorbent type, activated carbon) mounted thereon. The particulate filter may be a ceramic fiber sheet to provide particulate filtration and have a high operating temperature. A fuel element tray 310 is positioned adjacent the filter 308. Tray 310 also includes a center rib support 312 in this embodiment. The tray, along with tray insert 316, provides support for individual fuel element assemblies 314, which in this embodiment number 40 in each bank of assemblies. Additionally, insert 316 maintains a gap between adjacent elements for insulative purposes. The gap reduces heat transmission to adjacent elements thereby avoiding unneeded and therefore unwanted evolution of gas from elements adjacent an element that has been fired. The tray, insert and support need merely provide sufficient structural integrity for the application and be stable at the operating temperatures of the device. Aluminum is one example of a material with appropriate properties. Operably adjacent to the elements 200 is an igniter assembly 318. The igniter assembly 318 comprises initiating elements that were introduced herein before with numeral 16, but will be discussed for this embodiment with a new numeral hereinafter since they are not identical. The igniter assembly includes initiating elements 320 on each major surface of a circuit board 322. These assemblies are discussed hereunder. On a side opposite the side adjacent which the foregoing components have been identified and illustrated in the drawing, is an identical set of components. These components are numbered identically to the foregoing. The configuration as shown improves density of the device and therefore gravimetric efficiency.

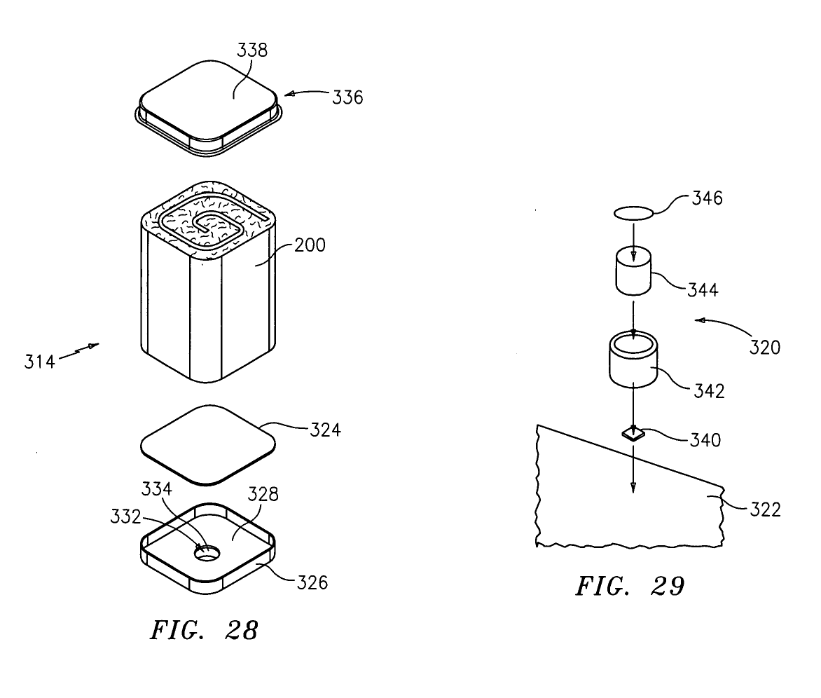

Referring to FIG. 28, an exploded view of a fuel element assembly 314 is provided. Each element assembly 314 comprises a fuel element 200, the volute embodiment being illustrated for exemplary purposes. The fuel element 200 is placed in contact with an igniter pad 324, which is in one embodiment, a paper which has been impregnated with a reactive material, such as A1-A (zirconium ferric oxide). The igniter paper is contained against one end of the fuel element 200 by a pad cap 326. The cap 326 includes a major portion 328 and a wall portion 330, the wall portion being dimensioned to closely fit to an element 200. The cap 326 further includes a through hole 332 with a boss 334 to align the cap 326 with a charge holder located on the circuit board 322 and discussed hereunder (note that boss and hole may also be offset to reduce cross talk between initiators on opposite sides of the board 322). At an end of the fuel element 200 from cap 326 is a cover 336 having dimensions and configuration similar to the cap 326 to help retain fuel element 200 in position and also having a perforate major portion 338 to facilitate passage of evolved gas from the fuel element 200. In one embodiment, the perforate portion is laser cut. The cap and cover may be of any material capable of withstanding the conditions of decomposition of the material used and in one embodiment if 6061 aluminum, utilized for its strength and light weight.

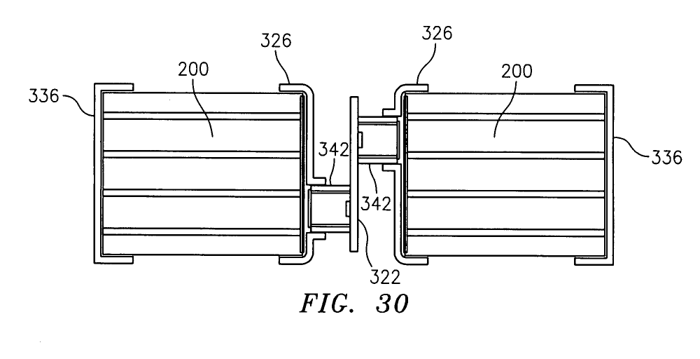

Referring to FIG. 29, an initiating element is illustrated in exploded form. Rather than being simply a semiconductor bridge or other of the initiators disclosed hereinabove, the initiator 320 comprises one of those initiators, here illustrated as a semiconductor bridge 340 which is mounted to a board 322 and in operable communication with a charge holder 342 (heat resistant, for example aluminum material). The holder 342 contains an ignition charge 344 and is closed with a closure disk 346. In use the disk is defeated by pressure and or heat 21. The initiator 320 is fixedly mounted to the board 322 and is receivable in the boss 334 shown in FIG. 30. Once the holder 342 is received in boss 334, the fuel element 200 remains in register with the initiator 320 reliably. As has been noted above this occurs on each surface of board 322. Such is well illustrated in FIG. 30.

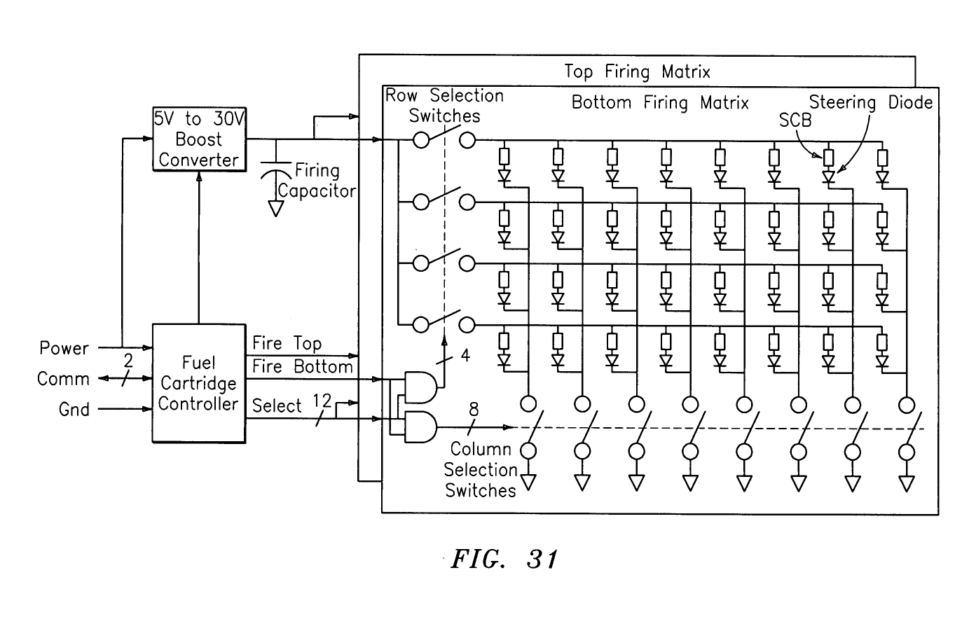

A control scheme for this embodiment is illustrated in FIG. 31. Discussion is not considered necessary as those of skill in the art will immediately recognize the common electrical symbols, which are specified in ANSI Y32.2-1975, Graphic Symbols for Electrical and Electronics Diagrams (incorporated herein by reference).

While preferred embodiments have been shown and described, modifications and substitutions may be made thereto without departing from the spirit and scope of the invention. Accordingly, it is to be understood that the present invention has been described by way of illustration and not limitation.

1. A gas generation arrangement comprising:
an initiating element;
a heat generating material in operable communication with the initiating element;
a gas evolution material in reactive communication with activity caused by the heat generating material; and
a barrier between the heat generating material and the gas evolution material.

2. A gas generation arrangement as claimed in claim 1 wherein said gas evolution material is responsive to heat energy.

3. A gas generation arrangement as claimed in claim 1 wherein said gas evolution material is responsive to water vapor.

4. A gas generation arrangement as claimed in claim 1 wherein said gas evolution material is responsive at sub-atmospheric pressure.

5. A gas generation arrangement as claimed in claim 1 wherein said barrier modifies heat output from the heat generating material.

6. A gas generation arrangement as claimed in claim 1 wherein the arrangement further comprises a catalyst.

7. A gas generation arrangement as claimed in claim 6 wherein the catalyst is a dehydrogenation catalyst.

8. A gas generation arrangement as claimed in claim 6 wherein the catalyst is for removal or reduction of impurities.

9. The gas generation arrangement as claimed in claim 1 wherein the initiating element is a semiconductor bridge.

10. The gas generation arrangement as claimed in claim 1 wherein the gas evolution material evolves gas at atmospheric pressure.

11. The gas generation arrangement as claimed in claim 1 wherein the gas generation arrangement operates to evolve a target gas without the operational parameter of hyperbaric pressure.

12. A barrier for a pyrolytic gas evolution arrangement comprising:
an expanse of material; and
one or more out-of-plane structures at the material, the one or more out-of-plane structures being receptive to a heat generating material at one surface of the material and an amount of a gas evolution material responsive to the heat generating material at an opposite surface of the material.

13. The barrier as claimed in claim 12 wherein the material is thermally conductive.

14. A pyrolytic gas generation arrangement comprising:
an initiating element;
a pyrotechnic in operable communication with the initiating element; and
a pyrolytic gas evolution material arranged relative to the pyrotechnic to be exposed to heat from the pyrotechnic in at least two major directions of heat transfer.

15. The pyrolytic gas generation arrangement as claimed in claim 14 wherein the material is arranged relative to the pyrotechnic to be exposed to heat from the pyrotechnic in five major directions of heat transfer.

16. A pyrotechnic gas generation arrangement comprising:
a semiconductor bridge;
a pyrotechnic in operable communication with the semiconductor bridge; and
a pyrolytic gas evolution material arranged relative to the pyrotechnic to be exposed to heat from the pyrotechnic.

17. A portable power source comprising:
a gas evolution arrangement having an initiating element;
a heat generating material in operable communication with the initiating element;
a gas evolution material;
a barrier between the heat generating material and the gas evolution material;
a fuel cell in operable communication with the gas evolution arrangement; and
a control having at least one sensor, the control in operable communication with the gas evolution arrangement and the fuel cell.

18. A portable power source as claimed in claim 17 wherein the control maintains gas supply at required levels on a demand basis.

19. A portable power source as claimed in claim 17 wherein the control monitors gas evolution material use.

20. A portable power source as claimed in claim 17 wherein the control predicts remaining time of cell operation.

21. The gas generation arrangement as claimed in claim 1 wherein the gas evolution material and the heat generation material are in the form of a plurality of discrete elements.

22. The gas generation arrangement as claimed in claim 21 wherein the elements each comprise a heat generating material and a gas evolution material and a barrier between the heat generation material and the gas evolution material.

23. The gas generation arrangement as claimed in claim 22 wherein each discrete element employs a tubular cross section having heat generating material in selected locations and substantially surrounded by gas evolution material.

24. The gas generation arrangement as claimed in claim 22 wherein the discrete elements are each tubular in structure and the heat generating material is centrally located relative to the tubular cross section and the gas evolution material is radially outwardly located relative to the heat generating material.

25. The gas generation arrangement as claimed in claim 24 wherein the heat generating material is disposed at an inner portion of a housing having radially outwardly extending spokes and the gas evolution material is disposed at a volume bounded by the inner housing portion and adjacent spokes and an outer housing portion.

26. The gas generation arrangement as claimed in claim 25 wherein the tubular cross section is cylindrical.

27. The gas generation arrangement as claimed in claim 24 wherein the tubular cross section is parallelogram shaped.

28. The gas generation arrangement as claimed in claim 22 wherein the barrier is a housing having a cylinder-like cross section and inwardly extending deformations and wherein the heat generating material is disposed at the deformations and the gas evolution material is disposed at the inside dimension of the housing.

29. The gas generation arrangement as claimed in claim 28 wherein the deformations are located about 120 degrees apart from one another.

30. The gas generation arrangement as claimed in claim 21 wherein the gas evolution material and the heat generating material are rolled together to form a volute.

31. The gas generation arrangement as claimed in claim 21 wherein at least one element of the plurality of discrete elements is maintained with a space from others of the plurality of elements.

32. The gas generation arrangement as claimed in claim 31 wherein the space is a gap.

33. The gas generation arrangement as claimed in claim 32 wherein at each element a gap exists.

34. A portable power source as claimed in claim 17 wherein the gas evolution arrangement is configured as a clip that is operably connectable to one or both of the fuel cell and control.

35. A portable power source as claimed in claim 34 wherein the clip includes an interlock feature to ensure gas connection before becoming operational.

36. A portable power source as claimed in claim 35 wherein the interlock connects gas fluidly before electrical connection is made.
